(19) United States
(12) Patent Application Publication
(10) Pub. No.: US 2022/0080230 A1
(43) Pub. Date: Mar. 17, 2022

(54) FACE MASK SYSTEM FOR COMMUNICATING WITH THE HEARING IMPAIRED

(71) Applicant: Mark Lamoncha, Columbiana, OH (US)

(72) Inventor: Mark Lamoncha, Columbiana, OH (US)

(21) Appl. No.: 17/474,872

(22) Filed: Sep. 14, 2021

Related U.S. Application Data
(60) Provisional application No. 63/077,811, filed on Sep. 14, 2020.

(51) Int. Cl. A62B 18/08; A41D 13/11; A62B 18/02; G06F 3/147

(52) U.S. Cl. CPC A62B 18/08; A41D 13/1161; G06K 9/00335; G06F 3/147; A62B 18/02

(57) ABSTRACT

A face mask system for communicating with the hearing impaired. The system includes a face mask having an interior surface that, when worn by a wearer, faces the wearer's mouth and is spaced a distance apart from the wearer's mouth. The system also includes a camera attached to the interior surface of the face mask that is configured to capture images of the wearer's mouth, and a transceiver that is configured to transfer the images to a computing device. The computing device then displays the captured images on a display screen. Also disclosed are embodiments where the computing device is a mobile device such as a smart phone or a smart watch. Further disclosed are exemplary face masks that may be utilized with the system.

### CROSS-REFERENCE TO RELATED APPLICATIONS

This application claims priority to U.S. Provisional Application No. 63/077,811, filed Sep. 14, 2020. The contents of U.S. Provisional Application No. 63/077,811 are hereby incorporated by reference as if fully recited herein.

### TECHNICAL FIELD

The application relates to face masks and, more particularly, to face masks that include a camera to capture the lip movements of the wearer.

### BACKGROUND

The global COVID-19 pandemic has elevated the importance of wearing PPE, especially in public places. Face masks are a type of personal protective equipment (PPE) that is commonly worn by a wearer to protect the wearer from harmful, or otherwise undesired, foreign particulate matter. This may include, for example, pathogens (e.g., viruses, bacteria, fungus, etc.), dust, pollen, soot, smoke, and liquid droplets. Further, by wearing it, the face mask may also prevent the spread of particulate matter (e.g., respirable particulate matter) from the wearer to the wearer's environment.

However, an increased emphasis on wearing face masks has been detrimental to people who are hearing impaired (i.e., any degree of hearing loss). This is because people who are hearing impaired commonly rely on observing the lip movements of others to decipher what they are saying. Therefore, wearing a face mask obviously hinders the wearer's ability to communicate with the hearing impaired since the face mask covers the wearer's lips. Accordingly, those skilled in the art continue with research and development efforts in the field of face masks.

### SUMMARY OF THE INVENTION

Disclosed are face mask systems for communicating with the hearing impaired. These systems include, among other things, a face mask, a camera, and a transceiver.

In one embodiment, the system includes a face mask configured to be worn over a wearer's mouth. The face mask includes an interior surface that faces the wearer's mouth. The interior surface is spaced a distance apart from the wearer's mouth when the wearer is wearing the face mask. The camera is attached to the interior surface of the face mask and is oriented towards the wearer's mouth. The camera is configured to capture images of the wearer's mouth when the wearer is wearing the face mask. The transceiver is configured to transmit images of the wearer's mouth from the camera to a computing device. The system also includes a computing device having a display screen, wherein the computing device is configured to receive images of the wearer's mouth from the transceiver and display those images on the display screen.

In another embodiment, the system includes a face mask that includes glasses and a face covering. The face covering includes a body, an attachment feature that enables attachment of the body to the glasses, and a filter portion configured to filter airflow to and from a wearer. The body and the filter portion collectively define an interior surface that faces the wearer when the wearer is wearing the face mask. The interior surface is spaced a distance apart from the wearer's mouth when the wearer is wearing the face mask. The camera is attached to the interior surface of the face mask and is oriented towards the wearer's mouth. The camera is configured to capture images of the wearer's mouth when the wearer is wearing the face mask. The transceiver is configured to transmit images of the wearer's mouth from the camera to a computing device. The system also includes a computing device having a display screen, wherein the computing device is configured to receive images of the wearer's mouth from the transceiver and display those images on the display screen.

In yet another embodiment, the system includes a face mask configured to be worn over a wearer's mouth. The face mask includes an interior surface that faces the wearer's mouth. The interior surface is spaced a distance apart from the wearer's mouth when the wearer is wearing the face mask. The camera is attached to the interior surface of the face mask and is oriented towards the wearer's mouth. The camera is configured to capture images of the wearer's mouth when the wearer is wearing the face mask. The transceiver is configured to transmit images of the wearer's mouth over a wireless network from the camera to a mobile device. The system also includes a mobile device having a display screen, wherein the mobile device is configured to receive images of the wearer's mouth from the transceiver and display those images on the display screen.

Other examples of the disclosed system will become apparent from the following detailed description, the accompanying drawings and the appended claims.

### BRIEF DESCRIPTION OF THE DRAWINGS

FIG. 1 is a front elevational view of a face mask and a computing device;

FIG. 2 is a top perspective view of the face mask of FIG. 1;

FIG. 3 is a bottom perspective view of the face mask of FIG. 1;

FIG. 4 is a rear view of the face mask of FIG. 1;

FIG. 5 is a top perspective view of a conventional face masking face mask being attached to the face mask of FIG. 1;

FIG. 6 is a top perspective view of a conventional face mask that is attached to the face mask of FIG. 1;

FIG. 7 is a front view of the face mask of FIG. 6;

FIG. 8 is a schematic illustration of the face mask system for communicating with the hearing impaired.

### DETAILED DESCRIPTION

The following detailed description refers to the accompanying drawings, which illustrate specific examples described by the disclosure. Other examples having different structures and operations do not depart from the scope of the present disclosure. Like reference numerals may refer to the same feature, element, or component in the different drawings.

Illustrative, non-exhaustive examples, which may be, but are not necessarily, claimed, of the subject matter according the present disclosure are provided below. Reference herein to “example” means that one or more feature, structure, element, component, characteristic and/or operational step described in connection with the example is included in at least one embodiment and/or implementation of the subject matter according to the present disclosure. Thus, the phrase “an example” and similar language throughout the present disclosure may, but does not necessarily, refer to the same example. Further, the subject matter characterizing any one example may, but does not necessarily, include the subject matter characterizing any other example.

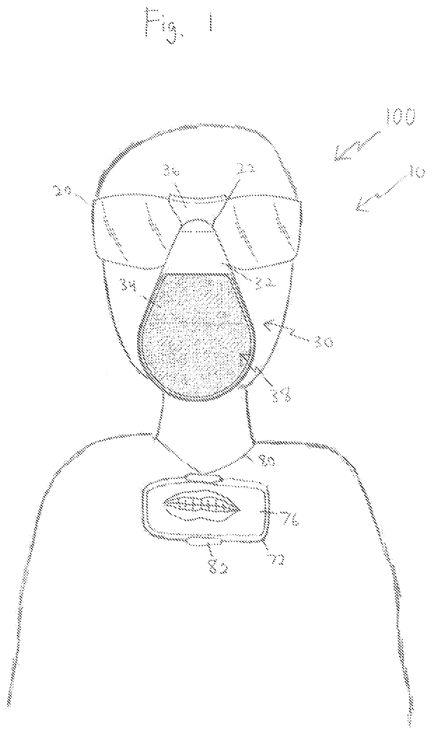

Referring to FIG. 1., the present disclosure relates to a face mask system 100 for communicating with the hearing impaired (herein, the “system”). The system 100 is configured to transmit visual images of a wearer's mouth to an electronic display 76. Thus, even when the wearer's mouth is covered by a mask other people may still see the wearer's mouth on the electronic display and discern meaning from the wearer's lip movements. In preferred embodiments, the system 100 may also include a microphone configured to detect and transmit audio from the wearer to an external speaker.

It is generally contemplated that the face mask system 100 might find the most utility when used with face masks that cover most, if not all, of the wearer's mouth. This would include, for example, face masks such as N95 respirators, KN95 respirators, surgical masks, face shields, and other types of face masks commonly worn in healthcare and industrial-type settings. However, as those skilled in the art will appreciate, the face mask system 100 can also be utilized with ostensibly any type of face mask, including those worn for otherwise recreational purposes (e.g., Halloween masks).

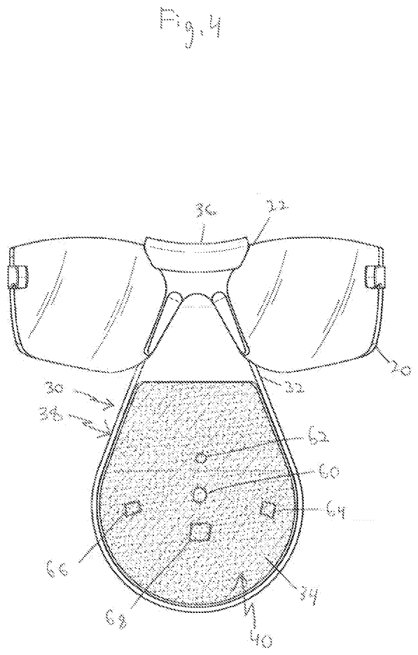

Referring to FIGS. 1-4, the present disclosure provides an exemplary embodiment of a face mask 10 that may be utilized with the system. This face mask 10 includes glasses 20 and face covering 30. The glasses 20 utilized here need not be limited to any particular type of glasses and can include various types such as safety glasses/goggles, prescription glasses, conventional sunglasses, and the like. Face covering 30 is attachable to the glasses 20 (e.g., to the bridge 22 of the glasses 20) and extends downwards over the wearer's nose and mouth. A wearer may wear this face mask 10 by putting on the glasses 20 and bringing the face covering 30 over his/her nose and mouth.

Face covering 30 includes a body 32, a filter portion 34, and an attachment feature 36. The attachment feature 36 is disposed along the top of the body 32 and enables the body 32 to be attached to the glasses 20. The filter portion 34 is disposed along the bottom of the body 32 and enables filtered airflow. The body 32 itself is configured to surround and encompass the wearer's nose and mouth such that all, or substantially all, airflow (e.g., breath) is directed through the filter portion 34.

The attachment feature 36 may include any suitable means for attaching the face covering 30 to the glasses 20. For example, the attachment feature 36 shown in FIGS. 1-4 is a clip configured to retain the bridge 22 of the glasses 20 in a press/friction/snap fit. This type of attachment may be releasable, thereby enabling the wearer to swap glasses if desired. Other means for attachment that may also be suitable here can include, for example, adhesives, fasteners, mechanical joints (e.g., dovetail), and/or the like. Alternatively, it is further contemplated that the face covering 30 may be integral with the glasses 20 (i.e., fabricated as a single piece).

Referring to FIG. 1, viewing the face mask 10 from the front shows that the body 32 of the face covering 30 may define a generally teardrop-shaped design that is wider at the bottom and narrower at the top (generally corresponding to the shape of a human nose and mouth). The overall physical dimensions of the face covering 30 may, but need not, be limited to any particular size. Rather, it is contemplated that the face covering 30 may be scaled either up or down in size to accommodate different wearers (e.g., youth/adult sizing, male/female sizing, etc.). Preferably, the body 32 may be tall enough to cover the wearer's face from about the bridge of the wearer's nose to about the bottom of the wearer's chin; and wide enough (at all points along its height) to provide ample room for the wearer's nose and mouth.

The material composition of the body 32 may, but need not, be a limiting feature. Various materials may be used to fabricate the body 32 such as, for example, silicone, neoprene, rubber, other types of polymeric materials, combinations thereof, and/or the like.

The body 32 also defines an opening 38 for receiving the filter portion 34. In the embodiment shown, the opening 38 extends from edge to edge horizontally across the lower part of the body 32, and from the bottom of the body 32 up to approximately where the apex of the wearer's nose would be. Ideally, the filter portion 34 should be closely received within this opening 38 with no air gaps defined therebetween (i.e., along the periphery of the filter portion 34). Other embodiments may vary by having, for example, either smaller or larger openings, openings of different shapes, or perhaps even multiple openings. Variations such as these will not depart from the scope of the present disclosure.

The filter portion 34 may be fabricated for any suitable type of filter material known to those of ordinary skill in the art of breathing filters. This can include, for example, cloth or filter paper material, or layers thereof. Ideally, the filter material may enable the wearer to breath easily while also filtering airborne particulate matter. Different embodiments of the system 100 may utilize different types of filter material, and filter materials may be selected based on their suitability for various applications.

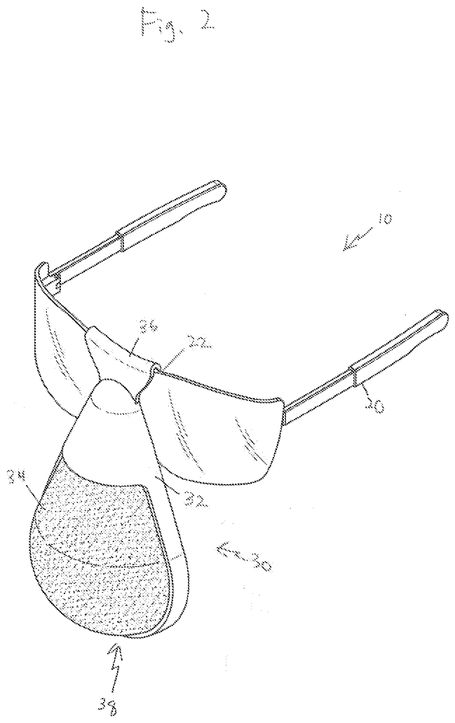

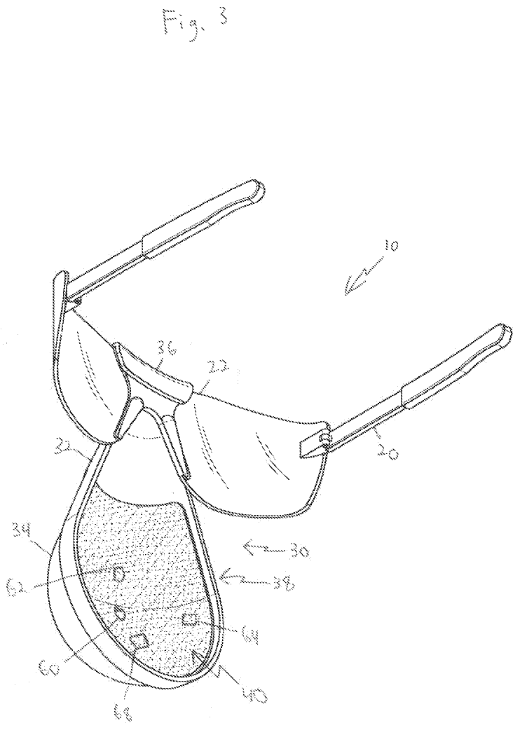

Referring to FIGS. 2 and 3, it is shown that the body 32 and the filter portion 34 both curve outwards and collectively define an interior space 40. A wearer's nose and mouth may be received within this interior space 40. Further, due to curvature of the body 32 and the filter portion 34, the body 32 and the filter portion 34 both define an interior surface that is spaced a distance apart from the wearer's nose and mouth even when the wearer is wearing the face covering 30. The degree of outward curvature, and thereby the volume of the interior space 40, should preferably provide enough room within the interior space 40 to avoid constraining or interfering with the wearer's lip movements. In exemplary embodiments, the outward curvature may also provide space for the incorporation of electric components (described in greater detail below).

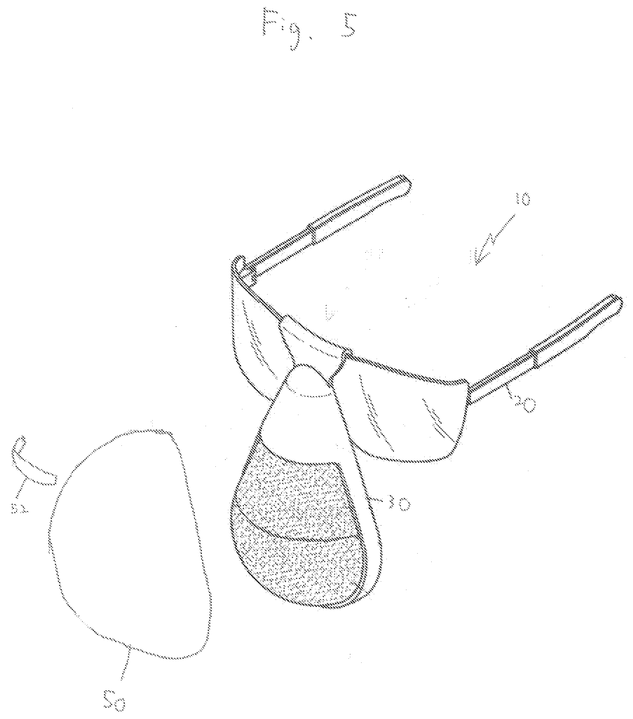

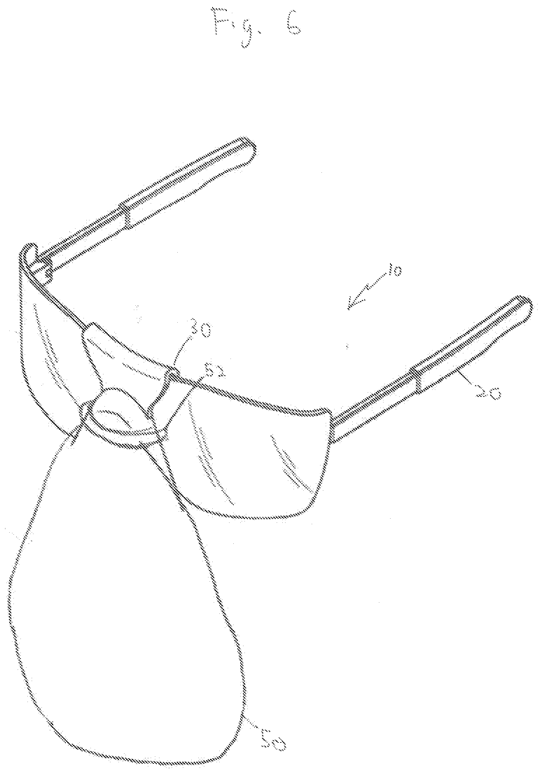

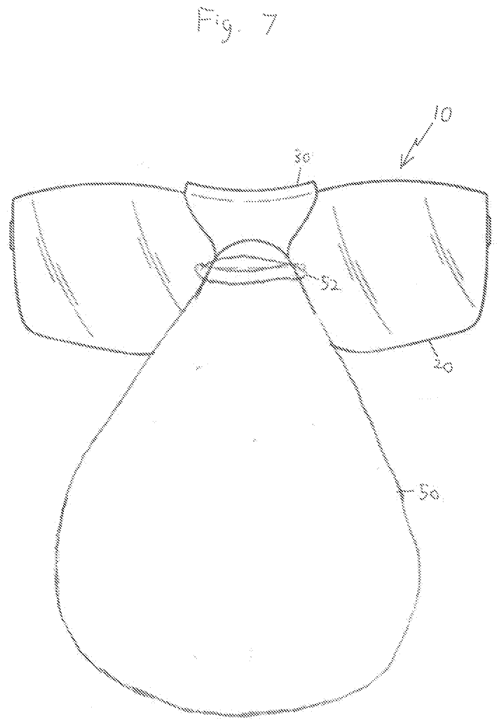

Referring to FIGS. 5-7, it is shown that the exemplary face mask 10 of FIGS. 1-4 may be worn with (i.e., in addition to) a conventional face mask. Examples of conventional face masks may include basic cloth face masks, surgical face masks, N95 respirators (e.g., the 3M™ Particulate Respirator 07048 available from 3M Corp. of Saint Paul, Minn.), KN95 respirators, and the like. As shown, the face mask 10 may be worn with an N95 respirator 50. Here, the N95 respirator 50 may be received over the front of the face covering. Further, a metallic strip/clip 52 may be provided that can be bent around the upper part of the face covering body (by the bridge of the nose) to secure the N95 respirator 52 to the face mask 10. Metallic strips/clips 52 of this sort are commonly provided for on commercially available N95 masks. As those skilled in the art will appreciate, the use of the metallic strip/clip 52 allow the N95 mask to be worn without straps (which may be uncomfortably short or otherwise undesirable to wear).

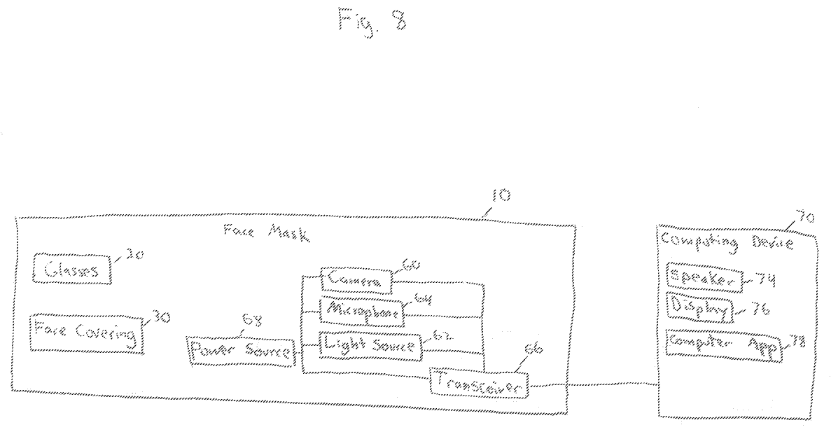

Referring to FIGS. 3, 4, and 8, the system further includes a camera 60 within the interior of a mask (i.e., the camera may form a part of the mask (be secured in the mask material), be secured onto a portion of the interior of the mask material, or may be positioned slightly apart from the mask but still interior to it when worn, between the mask and the wearer's face) that is configured to capture the wearer's lip movements. Preferably, the natural range of movement of the wearer's lips may remain within the frame of the camera shot when the wearer is talking. A camera having a wide-angle lens that is capable of operating with very short focal lengths may be preferable. It is contemplated that the type of camera and lens that would be suitable may be comparable to or of the types of cameras and lenses commonly found in mobile devices (e.g., smartphones).

In the embodiment shown, the camera 60 may be positioned directly in front of the wearer's mouth and attached to the interior surface of the face covering 30. This positioning ensures that the visual images (e.g., video recordings and still pictures) of the wearer's mouth is centered in the frame of the shot, as if one were to look at the wearer's mouth head-on. However, other camera locations (and thus, other visual angles) may also be utilized without departing from the scope of the present disclosure. Further, the camera 60 may also be configured to zoom, tilt, and/or pan so that adjustments to the frame of the shot may be made if desired. Additionally or alternatively, a light source 62 may also be provided to help illuminate the wearer's mouth.

In preferred embodiments, the camera 60 may be configured to capture a live video recording of the wearer's mouth, showing the fluid movement of the wearer's lips. It is generally contemplated that video recordings would be categorically preferred over still pictures because many hearing-impaired rely on lip movements to decipher what other people are saying. These lip movement are better shown on video than in photos.

In preferred embodiments, the system may also include a microphone 64 configured to capture audio from the wearer. This microphone 64 may either be integral with the camera 60 or provided as a separate component. It is contemplated that the microphone 64 may ideally be attached to the interior of a face mask, alongside the camera 60, but may be positioned elsewhere. In effect, inclusion of a microphone 64 may enable the system 100 to detect and transmit the wearer's voice when it would otherwise be muffled due to the wearer wearing a face mask. It is contemplated that the type of microphones that are suitable here may be comparable to or of the types of microphones commonly found in mobile devices (e.g., smartphones).

The camera 60 and the microphone 64 may each be in electronic communication with a transceiver 66 configured to transmit visual images and/or audio from the camera 60 and the microphone 64 to a computing device 80 (discussed below). This may entail providing a single transceiver 66 for both the camera 60 and the microphone 64 (as shown), or separate transceivers for both. In any case, the transceiver(s) 66 may be configured to operate over any suitable wireless network, such as WIFI or Bluetooth, preferably with little to no latency.

A power source 68 may be included to power the camera 60 and any other electronic device utilized by the system 100. The power source 68 may be located either external to or within the face mask. The power source 68 may also be integral with the camera 60, but need not be. Examples of suitable power sources 68 can include, but need not be limited to, internal batteries that each power an electronic component separately, a single internal battery that powers all of the electronic components collectively, and/or an external power bank that powers each component while the wearer carries the power bank on his/her person. In some embodiments, a charging port (e.g., micro USB) and the associated circuity may be provided so as to enable the rechargeability of the power source 68.

The electronic face mask components discussed above (e.g., the camera 60, the light source 62, the microphone 64, the transceiver 66, and the power source 68) may be attached to a face mask by any suitable means. For example, these components may be attached by way of adhesives. In another example, these components may be embedded in a face mask by way of a friction fit, press fit, snap fit, and the like. In yet another example, these components may even be molded into the face mask during fabrication of the face mask. Various other methods of attachment may be employed, none of which would result in a departure from the scope of the present disclosure.

Ideally, the electronic components should be as small as possible to avoid adding excess weight to the face mask, and to minimize crowding within the face mask. In one embodiment, a tiny camera may be used, such as a tiny camera that is commercially available from any number of micro camera companies known to those of ordinary skill the art, for example, the mini spy camera by Shenzhen Fuvision Electronics Co., LTD. of Shenzhen, Guangdong, China. Such micro cameras may come with a built-in microphone as well (not required in the invention but in some embodiments a microphone may be included), or if desired a separate microphone may be installed in the face mask.

The transceiver(s) 66 may establish a communication link between the electronic face mask components and one or more computing devices 70. As used herein, the term “computing device” refers to any configuration of electronic components and circuity (e.g., processor, memory, user input devices, etc.) known to those of ordinary skill in the art that may enable the functions described in this disclosure. For example, a transceiver 66 may be used to transmit visual images from the camera 60 to a personal computer, such as a desktop or laptop. In another example, a transceiver 66 may be used to transmit audio to a Bluetooth speaker. In yet another example, the transceiver 66 may be configured to transmit both audio and visual images to a mobile device such as a smartphone 72 or smartwatch. In turn, the computing device 70 can render the audio and/or visual images, and play the audio from an external speaker 74 and/or display the visual images on an electronic display screen 76.

Of course, wired connections between the electronic components and the one or more computing devices 70 may also be employed. However, such configurations are less preferred than wireless connections because wired connections are more likely to hinder the mobility of the wearer. Any suitable configuration of electronic components and circuitry may be provided to enable this type of connection.

The computing device 70 may be provided with computer executable instructions (i.e., software), saved on a non-transitory computer readable medium, that when executed by a processor causes the computing devices to generate a user interface on an electronic display screen 76. The user (e.g., the wearer and/or others) may access the user interface to gain access/control over one or more of the electronic components. In preferred embodiments, this software may be embodied in a computer application 78 loaded onto the memory of the computing device 70.

In one or more embodiments, the system 100 may include wearable features that the wearer may wear on his/her person. These wearable features may be particularly useful when the computing device 70 is a mobile device such as a smartphone 72 or smart watch. For example, as shown in FIG. 1, the wearable feature may include a necklace or lanyard 80 worn around the neck of the wearer. Connected to the necklace/lanyard 80, like a pendant, is a clip 82 to which the smartphone 72 may be attached. This configuration enables the wearer to display his/her smartphone 72 (and thereby the video of his/her mouth moving during speech) from around his/her neck in a hands-free manner. Of course, various other wearable features (e.g., bands, straps, belt holsters, etc.) may also be employed without departing from the scope of the present disclosure.

In one embodiment, the user may start (i.e., open) an associated video app running on his/her smartphone 72, activate the camera 60 mounted within his face mask 10 (which is likely opaque), the camera 60 being in wireless communication with the smartphone app 78, and begin to speak inside the face mask 10. The camera 60 may then capture the movement of the user's lips in substantially real time as he/she speaks, while the smartphone app 78 broadcasts those images on the electronic display screen 76 of the smartphone 72 for a hearing challenged listener to see the user's moving lips on the smartphone display screen 76 as the user speaks behind the face mask 10.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for communicating with the hearing-impaired, the system comprising:
a face mask configured to be worn over a wearer's mouth, the face mask comprising an interior surface that faces the wearer's mouth, and wherein the interior surface is spaced a distance apart from the wearer's mouth when the wearer is wearing the face mask;
a camera attached to the interior surface of the face mask that is oriented towards the wearer's mouth, wherein the camera is configured to capture images of the wearer's mouth when the wearer is wearing the face mask;
a transceiver configured to transmit images of the wearer's mouth from the camera to a computing device; and
a computing device comprising a display screen, wherein the computing device is configured to receive images of the wearer's mouth from the transceiver and display those images on the display screen.

2. The system of claim 1, wherein the camera is configured to capture the entirety of the wearer's mouth in the frame of the shot including the natural range of movement of the wearer's lips.

3. The system of claim 1, wherein:
the camera is configured to capture a live video recording of the wearer's mouth;
the transceiver is configured to transmit the live video recording to the computing device; and
the computing device is configured to display the live video recording on the display screen.

4. The system of claim 1, wherein the camera is configured to adjust the frame of the shot by at least one of zoom, pan, and tilt.

5. The system of claim 1, further comprising a light source attached to the interior surface of the face mask that is configured to illuminate the wearer's mouth when the wearer is wearing the face mask.

6. The system of claim 1 further comprising a microphone that is configured to capture audio from the wearer when the wearer is wearing the face mask, and wherein:
the transceiver is further configured to transmit the audio from the microphone to the computing device; and
the computing device further comprises a speaker and is configured to broadcast audio from the transceiver through the speaker.

7. The system of claim 6 wherein the microphone is attached to the interior surface of the face mask.

8. The system of claim 1, wherein the computing device further comprises computer executable instructions that, when executed, generates a user interface that enables a user to initiate and terminate image capturing by the camera.

9. The system of claim 1, wherein the transceiver is configured to transmit the images over at least one of a WIFI and Bluetooth wireless network.

10. A system for communicating with the hearing-impaired, the system comprising:
a face mask comprising glasses and a face covering, wherein:
the face covering comprises a body, an attachment feature that enables attachment of the body to the glasses, and a filter portion configured to filter airflow to and from a wearer;
the body and the filter portion collectively define an interior surface that faces the wearer when the wearer is wearing the face mask; and
the interior surface is spaced a distance apart from the wearer's mouth when the wearer is wearing the face mask;
a camera attached to the interior surface of the face mask that is oriented towards the wearer's mouth, wherein the camera is configured to capture images of the wearer's mouth when the wearer is wearing the face mask;
a transceiver configured to transmit images of the wearer's mouth from the camera to a computing device; and
a computing device comprising a display screen, wherein the computing device is configured to receive images of the wearer's mouth from the transceiver and display those images on the display screen.

11. The system of claim 10, wherein the attachment feature is a clip disposed along the top of the body that is configured to retain the bridge of the glasses in at least one of a friction fit, a press fit, and a snap fit.

12. The system of claim 11, wherein the clip is configured for releasable attachment.

13. The system of claim 10, wherein the body of the face mask is configured to cover the wearer's face from the approximate bridge of the wearer's nose to approximately the wearer's chin.

14. The system of claim 10, wherein the filter portion extends from the bottom of the body of the face covering up to approximately where the apex of the wearer's nose would be.

15. A system for communicating with the hearing-impaired, the system comprising:
a face mask configured to be worn over a wearer's mouth, the face mask comprising an interior surface that faces the wearer's mouth, and wherein the interior surface is spaced a distance apart from the wearer's mouth when the wearer is wearing the face mask;
a camera attached to the interior surface of the face mask that is oriented towards the wearer's mouth, wherein the camera is configured to capture images of the wearer's mouth when the wearer is wearing the face mask;
a transceiver configured to transmit images of the wearer's mouth over a wireless network from the camera to a mobile device; and
a mobile device comprising a display screen, wherein the mobile device is configured to receive images of the wearer's mouth from the transceiver and display those images on the display screen.

16. The system of claim 15, wherein the mobile device comprises at least one of a smartphone and a smart watch.

17. The system of claim 15 further comprising a wearable feature that enables the wearer of the face mask to display the mobile device in a hands-free manner.

18. The system of claim 17, wherein the wearable feature comprises a lanyard or necklace that is wearable around a wearer's neck, the wearable feature further comprising a clip connected to the lanyard or necklace like a pendant, and wherein the clip is configured to attach to and hold the mobile device.
